(19) United States
(12) Patent Application Publication
(10) Pub. No.: US 2008/0142827 A1
(43) Pub. Date: Jun. 19, 2008

(54) Pixel, display using the same, and driving method for the same

(76) Inventors: Sang-moo Choi, Suwon-si (KR); Jae-Kyeong Jeong, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/000,708

(22) Filed: Dec. 17, 2007

(30) Foreign Application Priority Data
Dec. 19, 2006 (KR) 10-2006-0130107
Dec. 19, 2006 (KR) 10-2006-0130108

(51) Int. Cl. H01L 51/50; G09G 3/30

(52) U.S. Cl. 257/98; 345/76; 257/E33.055

(57) ABSTRACT

A pixel may include a light emitting element, a first transistor, a second transistor, a storage capacitor, and a third transistor. The first transistor may be configured to transfer a data signal to a data line when a scan signal is supplied to a scan line. The second transistor may be configured to supply a predetermined electric current from a first power supply to a second power supply through the light emitting element. The storage capacitor may be charged with a voltage corresponding to the data signal, one terminal being coupled to a gate electrode of the first transistor, and another terminal being coupled to the organic light emitting diode. The third transistor may supply a voltage of a reference power supply to the light emitting element when the scan signal is supplied to the scan line.

### BACKGROUND

1. Field of the Invention

Embodiments relate to a pixel, a display using the pixel, and a driving method for the pixel, and more particularly, to a pixel, a display using the pixel, and a driving method for the pixel, which may display images of desired luminance regardless of a degradation of a light emitting element.

2. Description of the Related Art

Recently, various flat panel displays capable of providing reduced weight and volume compared with cathode ray tubes (CRT) have been developed. Flat panel displays include liquid crystal displays (LCD), field emission displays (FED), plasma display panels (PDP), and organic light emitting displays.

Among the flat panel displays, the organic light emitting displays make use of organic light emitting diodes that emit light by re-combination of electrons and holes. The organic light emitting display has numerous advantages, including fast response time and low power consumption.

A pixel of organic light emitting displays includes a light emitting element and a pixel circuit. The pixel circuit typically includes a storage capacitor charged with a voltage corresponding to a data signal, which is supplied to the light emitting element to display images of predetermined luminance. However, the conventional organic light emitting display cannot display images of desired luminance when the light emitting element degrades.

In detail, when a data signal is supplied to the pixel circuit, the storage capacitor is charged with a voltage corresponding to a difference between a voltage of the data signal and a voltage applied to the light emitting element. When the voltage applied to the light emitting element changes due to degradation of the light emitting element, the voltage charged in the storage capacitor changes accordingly. Thus, images of desired luminance may not be displayed.

### SUMMARY OF THE INVENTION

Embodiments are therefore directed to a pixel, display using the pixel, and a method of driving the pixel, which substantially overcome one or more of the problems due to the limitations and disadvantages of the related art.

It is therefore an aspect of an embodiment to provide a pixel, a display using the pixel, and a method of driving the pixel, which may display images of desired luminance regardless of a degradation of a light emitting element of the pixel.

The foregoing and/or other aspects of an embodiment may be realized by providing a pixel including a light emitting element, a first transistor configured to transfer a data signal to a data line when a scan signal is supplied to a scan line, a second transistor configured to supply a predetermined electric current from a first power supply to a second power supply through the organic light emitting diode, a storage capacitor configured to be charged with a voltage corresponding to the data signal, one terminal of the storage capacitor being coupled to a gate electrode of the first transistor, and another terminal of the storage capacitor being coupled to the light emitting element, and a third transistor configured to supply a voltage of a reference power supply to the light emitting element when the scan signal is supplied to the scan line.

The storage capacitor may be charged with a voltage corresponding to a difference between the voltage of the data signal and the voltage of the reference power supply. The predetermined electric current may be an electric current corresponding to the voltage charged in the storage capacitor. The voltage of the reference power supply may be less than a sum of the voltage of the first power supply and a threshold voltage of the light emitting element. The first to third transistors may be an NMOS transistor.

The pixel may further include a fourth transistor coupled between the second transistor and the first power supply, the fourth transistor being configured to be turned off when an emission control signal is supplied to an emission control line, and otherwise turned on. The emission control signal may be low when the scan signal is high. The fourth transistor may include an NMOS transistor.

The foregoing and/or other aspects of an embodiment may be realized by providing a scan driver configured to drive scan lines; a data driver configured to drive data lines, and pixels disposed at intersections of the scan lines and the data lines. Each of the pixels may include a light emitting element, a first transistor configured to transfer a data signal to a data line when a scan signal is supplied to a scan line, a second transistor configured to supply a predetermined electric current from a first power supply to a second power supply through the light emitting element, a storage capacitor configured to be charged with a voltage corresponding to the data signal, one terminal of the storage capacitor being coupled to a gate electrode of the first transistor, and another terminal of the storage capacitor being coupled to the light emitting element, and a third transistor configured to supply a voltage of a reference power supply to the light emitting element when the scan signal is supplied to the scan line.

The storage capacitor may be charged with a voltage corresponding to a difference between the voltage of the data signal and the voltage of the reference power supply. The predetermined electric current may be an electric current corresponding to the voltage charged in the storage capacitor. The voltage of the reference power supply may be less than a sum of the voltage of the first power supply and a threshold voltage of the light emitting element. The first to third transistors may include an NMOS transistor.

The display may include a fourth transistor coupled between the second transistor and the first power supply, the fourth transistor configured to be turned off when an emission control signal is supplied to an emission control line, and otherwise turned on. The emission control signal may be low when the scan signal is high.

The foregoing and/or other aspects of an embodiment may be realized by providing a method of driving a display including a pixel at an intersection of a data line and a scan line, the pixel having a light emitting element, the method including transferring a data signal to the data line when a scan signal is supplied to the scan line, supplying a predetermined electric current from a first power supply to a second power supply through the light emitting element, and supplying a voltage of a reference power supply to the light emitting element when the scan signal is supplied to the scan line.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a display according to a first embodiment;

FIG. 2 illustrates a circuit diagram of an example pixel for use in the display of FIG. 1;

FIG. 3 illustrates a waveform diagram of an example driving method of the example pixel of FIG. 2;

FIG. 4 illustrates a graph of a change of an electric current according to the degradation of a light emitting element;

FIG. 5 illustrates a display according to a second embodiment;

FIG. 6 illustrates a circuit diagram of an example pixel for use in the display of FIG. 5; and

FIG. 7 illustrates a waveform diagram of an example driving method of the example pixel of FIG. 6.

### DETAILED DESCRIPTION OF EMBODIMENTS

Korean Patent Application Nos. 10-2006-0130107, filed on Dec. 19, 2006 and 10-2006-0130108, filed on Dec. 19, 2006, in the Korean Intellectual Property Office, and entitled: “Pixel and Organic Light Emitting Display Using the Same,” is incorporated by reference herein in its entirety.

Hereinafter, certain exemplary embodiments according to the present invention will be described with reference to the accompanying drawings. Here, when a first element is described as being connected or coupled to second element, the first element may be not only directly connected or coupled to the second element but may also be indirectly connected or coupled to the second element via a third element. Further, elements that are not essential to the complete understanding of the invention are omitted for clarity. Also, like reference numerals refer to like elements throughout.

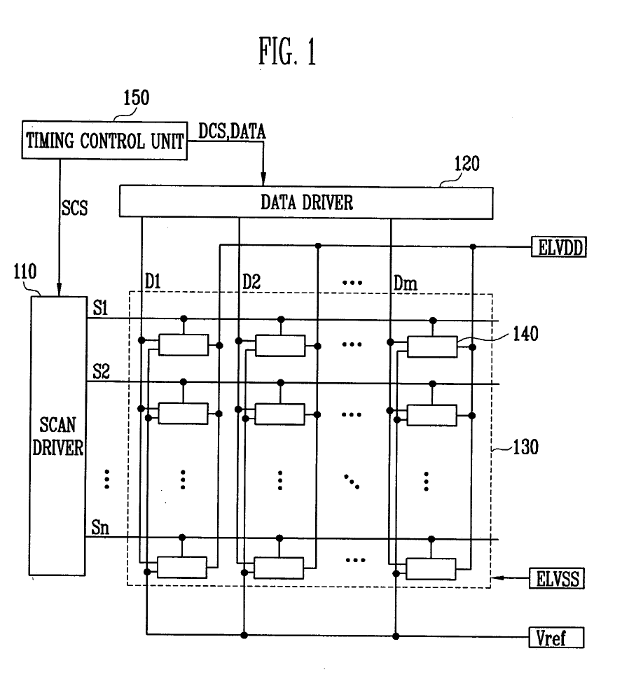

FIG. 1 illustrates a display according to a first embodiment. With reference to FIG. 1, the display may include a pixel portion 130, a scan driver 110, a data driver 120, and a timing control unit 150.

The pixel portion 130 may include a plurality of pixels 140 coupled with scan lines S1 to Sn and data lines D1 to Dm. The scan driver 110 may drive the scan lines S1 to Sn. The data driver 120 may drive the data lines D1 to Dm. The timing control unit 150 may control the scan driver 110 and the data driver 120.

The timing controller 150 may generate a data driving signal DCS and a scan driving signal SCS corresponding to external synchronizing signals. The data driving signal DCS may be provided to the data driver 120, and the scan driving signal SCS may be provided to the scan driver 110. Further, the timing control unit 150 may provide an externally supplied data DATA to the data driver 120.

The scan driver 110 may receive the scan driving control signal SCS from the timing control unit 150. In response to the scan driving control signal SCS, the scan driver 110 may sequentially provide a scan signal to the scan lines S1 through Sn.

The data driver 120 may receive a data driving signal DCS and data DATA from the timing controller 150. In response to the data driving signal DCS, the data driver 120 may generate and provide a data signal to the data lines D1 through Dm in accordance with data DATA.

The pixel portion 130 may receive power from external power supplies, e.g., a first power supply ELVDD, a second power supply ELVSS, and a reference power supply Vref, and may provide power to the pixels 140. When the pixels 140 receive power of the first power supply ELVDD, power of the second power supply ELVSS, and power of the reference power supply Vref, the pixels 140 may generate light corresponding to the data signal.

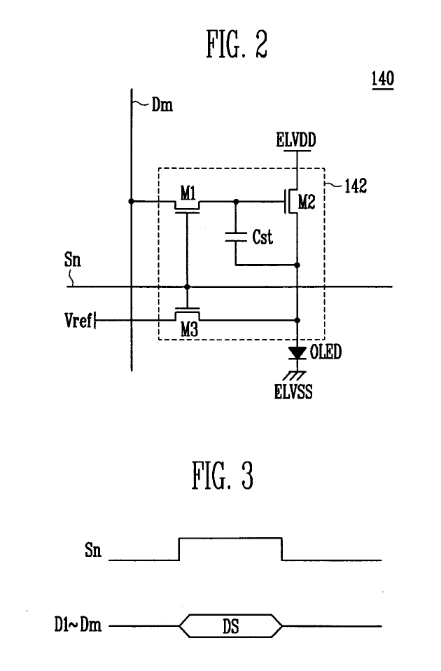

FIG. 2 illustrates a circuit diagram of an example pixel for use in the display of FIG. 1. For convenience of the description, FIG. 2 illustrates the example pixel coupled to an n-th scan line Sn and an m-th data line Dm.

With reference to FIG. 2, the pixel 140 may include a light emitting element, here, an organic light emitting diode OLED, and a pixel circuit 142. The pixel circuit 142 may be connected to the data line Dm and the scan line Sn, and may control the organic light emitting diode OLED.

An anode electrode of the organic light emitting diode OLED may be connected to the pixel circuit 142, and a cathode electrode thereof may be connected to the second power supply ELVSS. The organic light emitting diode OLED may generate light having a predetermined luminance corresponding to an electric current from the pixel circuit 142.

When the scan signal is supplied to the scan line Sn, the pixel circuit 142 may control an amount of an electric current supplied to the organic light emitting diode OLED in accordance with the data signal supplied to the data line Dm. To realize this control, the pixel circuit 142 may include a first transistor M1, a second transistor M2, a storage capacitor Cst, and a third transistor M3. All of the transistors may be the same type, e.g., the first transistor M1 through the third transistor M3 may each be an NMOS transistor.

The second transistor M2 may be coupled between the first power supply ELVDD and the organic light emitting diode OLED. The first transistor M1 may be coupled between the second transistor M2 and the data line Dm, and may be controlled by the scan line Sn. The storage capacitor Cst may be coupled between a gate electrode and a second electrode of the second transistor M2. The third transistor M3 may be coupled between the second electrode of the second transistor M2 and the reference power supply Vref, and may be controlled by the scan lien Sn.

A gate electrode of the first transistor M1 may be coupled to the scan line Sn, and a first electrode of the first transistor M1 may be coupled to the data line Dm. Further, a second electrode of the first transistor M1 may be coupled to one terminal of the storage capacitor Cst. When the scan signal is from the scan line Sn, the first transistor M1 is turned on and transfers the data signal supplied to the data line Dm to the gate electrode of the second transistor M2. At this time, the storage capacitor Cst is charged with a voltage corresponding to the data signal.

The gate electrode of the second transistor M2 may be coupled with one terminal of the storage capacitor Cst, and a first electrode of the second transistor M2 may be coupled to the first power supply ELVDD. The second electrode of the second transistor M2 may be coupled to another terminal of the storage capacitor Cst and the anode electrode of the organic light emitting diode OLED. The second transistor M2 may control an amount of an electric current flowing from the first power supply ELVDD to the second power supply ELVSS through the organic light emitting diode OLED in accordance with a voltage value stored in the storage capacitor Cst.

One terminal of the storage capacitor Cst may be coupled to the gate electrode of the second transistor M2, and another terminal of the storage capacitor Cst may be coupled to the anode electrode of the organic light emitting diode OLED. The storage capacitor Cst may be charged with the voltage corresponding to the data signal.

A gate electrode of the third transistor M3 may be coupled to the scan line Sn, and a second electrode of the third transistor M3 may be coupled to the anode electrode of the organic light emitting diode OLED. Further, a first electrode of the third transistor M3 may be coupled to the reference power supply Vref. When a scan signal is supplied to the scan line Sn, the third transistor M3 is turned on to maintain a voltage of the anode electrode of the organic light emitting diode OLED with a voltage of the reference power supply Vref. That is, while one terminal of the storage capacitor Cst is charged with the voltage corresponding to the data signal, another terminal of the storage capacitor Cst is maintained at a voltage of the reference power supply Vref.

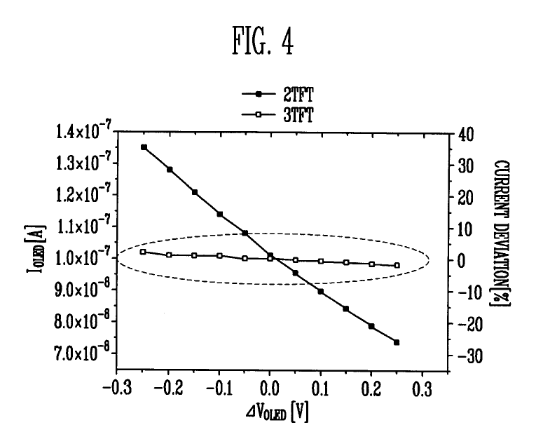

FIG. 3 illustrates a waveform diagram of an example driving method of the pixel of FIG. 2. With reference to FIG. 2 and FIG. 3, firstly, the scan signal is supplied to the scan line Sn, i.e., the scan signal is high. When the scan signal is supplied to the scan line Sn, the first transistor M1 and the third transistor M3 are turned on.

When the third transistor M3 is turned on, a voltage of the reference power supply Vref is supplied to the anode electrode of the organic light emitting diode OLED. When the first transistor M1 is turned on, the data signal supplied to the data line Dm is provided to one terminal of the storage capacitor Cst. In this case, the storage capacitor Cst is charged with a voltage corresponding to a difference between a voltage of the data signal and a voltage of the reference power supply Vref. In other words, the storage capacitor Cst is charged with the voltage corresponding to the data signal irrespective of a degradation of the organic light emitting diode OLED. Thus, when one terminal of the storage capacitor Cst is charged with the voltage corresponding to the data signal, since another terminal of the storage capacitor Cst is maintained at a voltage of the reference power supply Vref, the storage capacitor Cst may be charged with a desired voltage.

When supply of the scan signal to the scan line Sn stops, the second transistor M2 supplies an electric current corresponding to the voltage charged in the storage capacitor Cst from the first power supply ELVDD to the second power supply ELVSS through the organic light emitting diode OLED. Accordingly, the organic light emitting diode OLED may generate light of predetermined luminance.

The voltage of the first power supply ELVDD may be set to be greater than that of the second power supply ELVSS to stably supply the electric current. The voltage of the reference power supply Vref may be set to a voltage less than a sum of the voltage of the first power supply ELVDD and a threshold voltage of the organic light emitting diode OLED.

FIG. 4 illustrates a graph of a change of an electric current according to the degradation of an organic light emitting diode. In FIG. 4, IOLED represents an amount of an electric current flowing through the organic light emitting diode OLED, and ΔVOLED indicates a variation of a voltage applied to the anode electrode of the organic light emitting diode OLED due to the degradation of the organic light emitting diode OLED. Further, in FIG. 4, a voltage of the data signal is set to flow an electric current of 100 nA to the organic light emitting diode OLED.

Referring to FIG. 4, in a pixel including a pixel circuit having two transistors, when a voltage of the anode electrode of the organic light emitting diode OLED varies, an electric current IOLED of the organic light emitting diode OLED also varies. In this particular example, the voltage of the organic light emitting diode OLED varies by 0.2V and an electric current IOLED deviation of the organic light emitting diode OLED is 28%. Consequently, it is difficult to display images of desired luminance using this pixel.

However, in accordance with an embodiment in which a pixel circuit has three transistors, although the voltage of the organic light emitting diode OLED changes, the electric current IOLED of the organic light emitting diode OLED is maintained. Accordingly, the example pixel may display images of desired luminance regardless of the degradation of the organic light emitting diode OLED.

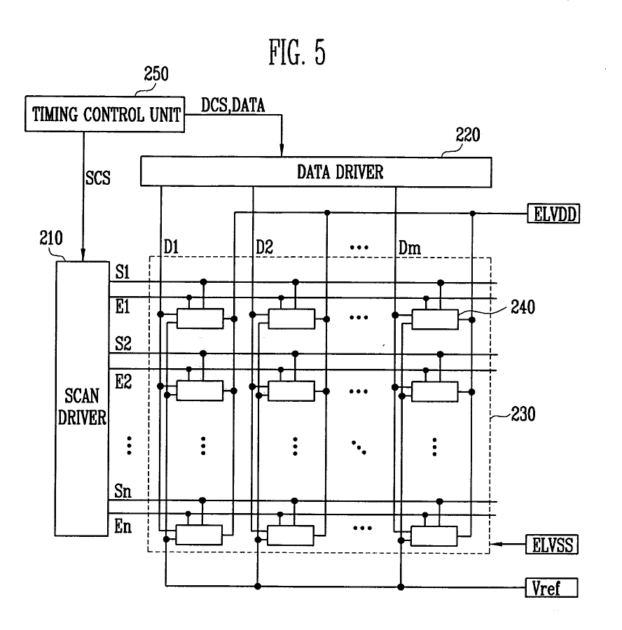

FIG. 5 illustrates a display according to a second embodiment. With reference to FIG. 5, the display may include a pixel portion 230, a scan driver 210, a data driver 220, and a timing control unit 250.

The pixel portion 230 may include a plurality of pixels 240 coupled to scan lines S1 to Sn, emission control lines E1 to En, and data lines D1 to Dm. The scan driver 210 may drive the scan lines S1 to Sn and the emission control lines E1 to En. The data driver 220 may drive the data lines D1 to Dm. The timing control unit 250 may control the scan driver 210 and the data driver 220.

The timing controller 250 may generate a data driving signal DCS and a scan driving signal SCS corresponding to synchronizing signals supplied from an exterior. The data driving signal DCS may provided to the data driver 220, and the scan driving signal SCS may be provided to the scan driver 210. Further, the timing control unit 250 may provide an externally supplied data DATA to the data driver 220.

The scan driver 210 may receive the scan driving control signal SCS from the timing control unit 250. In response to the scan driving control signal SCS, the scan driver 210 may sequentially provide a scan signal to the scan lines S1 through Sn. Further, the scan driver 210 may generate an emission control signal and may sequentially provide the emission control signal to the emission control lines E1 through En. A width of an emission control signal supplied to an i-th emission control line may be set so that the emission control signal is not high when the scan signal supplied to an i-th scan line is high.

The data driver 220 may receive the data driving signal DCS and data DATA from the timing controller 250. In response to the data driving signal DCS, the data driver 220 may generates and provides a data signal to the data lines D1 through Dm in accordance with the data DATA.

The pixel portion 230 may receive power from external power sources, e.g., the first power supply ELVDD, the second power supply ELVSS, and the reference power supply Vref, and may provide them to the pixels 240. When the pixels 240 receive the power of the first power supply ELVDD, the power of the second power supply ELVSS, and power of the reference power supply Vref, they generate light corresponding to the data signal.

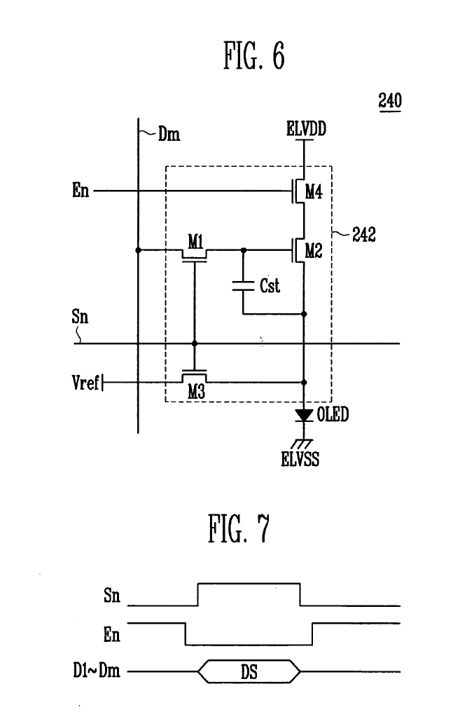

FIG. 6 illustrates a circuit diagram of an example pixel for use in the display of FIG. 5. For convenience of the description, FIG. 6 illustrates the example pixel coupled to an n-th scan line Sn and an m-th data line Dm.

Referring to FIG. 6, the pixel 240 according to an embodiment may include a light emitting element, here, the organic light emitting diode OLED, and a pixel circuit 242. The pixel circuit 242 may be coupled to the data line Dm, the emission control line En, and the scan line Sn, and may control the organic light emitting diode OLED.

The anode electrode of the organic light emitting diode OLED may be coupled to the pixel circuit 242, and the cathode electrode thereof may be coupled to a second power supply ELVSS. The organic light emitting diode OLED may generate light of predetermined luminance corresponding to an electric current supplied from the pixel circuit 242.

When a scan signal is supplied to the scan line Sn, the pixel circuit 242 may control an amount of an electric current supplied to the organic light emitting diode OLED in accordance with the data signal supplied to the data line Dm. To realize this control, the pixel circuit 242 may include the first transistor M1, the second transistor M2, the storage capacitor Cst, the third transistor M3, and a fourth transistor M4. Here, the first transistor M1 through the fourth transistor M4 may each be the same type, e.g., an NMOS transistor.

The fsecond transistor M2 may be coupled between the fourth transistor M4 and the organic light emitting diode OLED. The first transistor M1 may be coupled between the second transistor M2 and the data line Dm, and may be controlled by the scan line Sn. The storage capacitor Cst may be coupled between the gate electrode and the second electrode of the second transistor M2. The third transistor M3 may be coupled between the second electrode of the second transistor M2 and the reference power supply Vref, and may be controlled by the scan line Sn. The fourth transistor M4 may be coupled between the first power supply ELVDD and the first electrode of the second transistor M2, and may be controlled by the emission control line En.

The gate electrode of the first transistor M1 may be coupled to the scan line Sn, and the first electrode of the first transistor M1 may be coupled to the data line Dm. Further, the second electrode of the first transistor M1 may be coupled to one terminal of the storage capacitor Cst. When the scan signal is supplied from the scan line Sn, the first transistor M1 is turned on and transfers the data signal supplied to the data line Dm to the gate electrode of the second transistor M2. At this time, the storage capacitor Cst is charged with a voltage corresponding to a data signal.

The gate electrode of the second transistor M2 may be coupled to one terminal of the storage capacitor Cst, and the first electrode of the second transistor M2 may be coupled to a second electrode of the fourth transistor M4. The second electrode of the second transistor M2 may be coupled to another terminal of the storage capacitor Cst and the anode electrode of the organic light emitting diode OLED. The second transistor M2 may control an amount of an electric current flowing from the first power supply ELVDD to the second power supply ELVSS through the organic light emitting diode OLED corresponding to a voltage value stored in the storage capacitor Cst.

One terminal of the storage capacitor Cst may be coupled to the gate electrode of the second transistor M2, and another terminal of the storage capacitor Cst may be coupled to the anode electrode of the organic light emitting diode OLED. The storage capacitor Cst is charged with the voltage corresponding to the data signal.

The gate electrode of the third transistor M3 may be coupled to the scan line Sn, and the second electrode thereof may be coupled to an anode electrode of the organic light emitting diode OLED. Further, the first electrode of the third transistor M3 may be coupled to the reference power supply Vref. When a scan signal is supplied to the scan line Sn, the third transistor M3 is turned on to maintain a voltage of the anode electrode of the organic light emitting diode OLED to be a voltage of the reference power supply Vref. That is, while one terminal of the storage capacitor Cst is charged with the voltage corresponding to the data signal, another terminal of the storage capacitor Cst is maintained at a voltage of the reference power supply Vref.

A gate electrode of the fourth transistor M4 may be coupled to an emission control line En, and a first electrode of the fourth transistor M4 may be coupled to the first power supply ELVDD. The second electrode of the fourth transistor M4 may be coupled to the first electrode of the second transistor M2. While an emission control signal is supplied, the fourth transistor M4 electrically isolates the second transistor M2 from the first power supply ELVDD. During remaining time periods, the fourth transistor M4 electrically connects the second transistor M2 to the first power supply ELVDD.

FIG. 7 illustrates a waveform diagram showing an example driving method for the example pixel of FIG. 6. As can be seen in FIG. 7, when the scan control signal is supplied, i.e., is high, the emission control signal is not supplied, i.e., the emission control signal is low. As can be further seen in FIG. 7, the emission control signal may be low before the scan control signal is high, and the scan control signal may be low before the emission control signal is high.

Referring to FIG. 6 and FIG. 7, firstly, an emission control signal is supplied to the emission control line En. When the emission control signal is supplied to the emission control line En, the fourth transistor M4 is turned off. When the fourth transistor M4 is turned off, the second transistor M2 is electrically isolated from the first power supply ELVDD, thereby preventing unnecessary electric current from flowing to the organic light emitting diode OLED.

Next, a scan signal is supplied to the scan line Sn. When the scan signal is supplied to the scan line Sn, the first transistor M1 and the third transistor M3 are turned on.

When the third transistor M3 is turned on, a voltage of the reference power supply Vref is supplied to the anode electrode of the organic light emitting diode OLED. When the first transistor M1 is turned on, the data signal to be supplied to the data line Dm is provided to one terminal of the storage capacitor Cst. In this case, the storage capacitor Cst is charged with a voltage corresponding to a difference between a voltage of the data signal and a voltage of the reference power supply Vref. Thus, the storage capacitor Cst is charged with the voltage corresponding to the data signal irrespective of a degradation of the organic light emitting diode OLED. In other words, when one terminal of the storage capacitor Cst is charged with the voltage corresponding to the data signal, because another terminal of the storage capacitor Cst is maintained at a voltage of the reference power supply Vref, the storage capacitor Cst may be charged with a desired voltage.

When the scan signal to the scan line Sn becomes low, the first transistor M1 and the third transistor M3 are turned off. When the emission control signal to the emission control line En becomes high, e.g., after the scan signal has become low, the fourth transistor M4 is turned on. At this time, the second transistor M2 supplies an electric current corresponding to the voltage charged in the storage capacitor Cst from the first power supply ELVDD to the second power supply ELVSS through the organic light emitting diode OLED. Accordingly, the organic light emitting diode OLED may generate light of predetermined luminance.

The voltage of the first power supply ELVDD may be set to be greater than that of the second power supply ELVSS to stably supply the electric current. The voltage of the reference power supply Vref may be set to a voltage less than a sum of the voltage of the first power supply ELVDD and a threshold voltage of the organic light emitting diode OLED.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A pixel, comprising:
a light emitting element;
a first transistor configured to transfer a data signal to a data line when a scan signal is supplied to a scan line;
a second transistor configured to supply a predetermined electric current from a first power supply to a second power supply through the light emitting element;
a storage capacitor configured to be charged with a voltage corresponding to the data signal, one terminal of the storage capacitor being coupled to a gate electrode of the first transistor, and another terminal of the storage capacitor being coupled to the light emitting element; and
a third transistor configured to supply a voltage of a reference power supply to the light emitting element when the scan signal is supplied to the scan line.

2. The pixel as claimed in claim 1, wherein the storage capacitor is configured to be charged with a voltage corresponding to a difference between the voltage of the data signal and the voltage of the reference power supply.

3. The pixel as claimed in claim 2, wherein the predetermined electric current is an electric current corresponding to the voltage charged in the storage capacitor.

4. The pixel as claimed in claim 1, wherein the voltage of the reference power supply is less than a sum of the voltage of the first power supply and a threshold voltage of the light emitting element.

5. The pixel as claimed in claim 1, wherein the first to third transistors include an NMOS transistor.

6. The pixel as claimed in claim 1, further comprising a fourth transistor coupled between the second transistor and the first power supply, the fourth transistor being configured to be turned off when an emission control signal is supplied to an emission control line and to be turned on otherwise.

7. The pixel as claimed in claim 6, wherein the emission control signal is not high while the scan signal is high.

8. The pixel as claimed in claim 6, wherein the fourth transistor includes an NMOS transistor.

9. The pixel as claimed in claim 1, wherein the light emitting element is an organic light emitting diode.

10. A display, comprising:
a scan driver configured to drive scan lines;
a data driver configured to drive data lines; and
pixels disposed at intersections of the scan lines and the data lines,
each of the pixels including:
a light emitting element;
a first transistor configured to transfer a data signal to a data line when a scan signal is supplied to a scan line;
a second transistor configured to supply a predetermined electric current from a first power supply to a second power supply through the light emitting element;
a storage capacitor configured to be charged with a voltage corresponding to the data signal, one terminal of the storage capacitor being coupled to a gate electrode of the first transistor, and another terminal of the storage capacitor being coupled to the light emitting element; and
a third transistor configured to supply a voltage of a reference power supply to the light emitting element when the scan signal is supplied to the scan line.

11. The display as claimed in claim 10, wherein the storage capacitor is configured to be charged with a voltage corresponding to a difference between the voltage of the data signal and the voltage of the reference power supply.

12. The display as claimed in claim 11, wherein the predetermined electric current is an electric current corresponding to the voltage charged in the storage capacitor.

13. The display as claimed in claim 10, wherein the voltage of the reference power supply is less than a sum of the voltage of the first power supply and a threshold voltage of the light emitting element.

14. The display as claimed in claim 10, wherein the first to third transistors include an NMOS transistor.

15. The display as claimed in claim 10, further comprising a fourth transistor coupled between the second transistor and the first power supply, the fourth transistor configured to be turned off when an emission control signal is supplied to an emission control line and otherwise turned on.

16. The display as claimed in claim 15, wherein the emission control signal is not high while the scan signal is high.

17. The display as claimed in claim 10, wherein the light emitting element is an organic light emitting diode.

18. A method of driving a display including a pixel at an intersection of a data line and a scan line, the pixel having a light emitting element, the method comprising:
transferring a data signal to the data line when a scan signal is supplied to the scan line;
supplying a predetermined electric current from a first power supply to a second power supply through the light emitting element; and
supplying a voltage of a reference power supply to the light emitting element when the scan signal is supplied to the scan line.

19. The method as claimed in claim 18, wherein supplying the predetermined electric current occurs only when no scan signal is supplied to the scan line.
